(19) United States
(12) Patent Application Publication
(10) Pub. No.: US 2013/0083195 A1
(43) Pub. Date: Apr. 4, 2013

(54) POLARIZATION-BASED ANTI-BLINDING NIGHT VISION SYSTEM, VEHICLE COMPRISING SAME, AND METHOD THEREFOR

(71) Applicants: Jeffrey Thomas Remillard, Ypsilanti, MI (US); Kenneth Edward Nietering, Dearborn, MI (US)

(72) Inventors: Jeffrey Thomas Remillard, Ypsilanti, MI (US); Kenneth Edward Nietering, Dearborn, MI (US)

(21) Appl. No.: 13/250,914

(22) Filed: Sep. 30, 2011

(51) Int. Cl. H04N 5/30; H04N 7/18

(52) U.S. Cl. 348/148; 348/162; 348/E05.085; 348/E07.085

(57) ABSTRACT

A night vision system has a night vision illuminator, an imaging apparatus, and a first light conditioning structure. The night vision illuminator is configured for illuminating a space with near-infrared (NIR) light that is linearly polarized in a direction substantially parallel with a first polarization axis. The imaging apparatus is configured for creating an electrical representation of an image defined by NIR light received thereby. A field of view of the imaging apparatus includes at least a portion of the space illuminated with the NIR light of the night vision illuminator. The first light conditioning structure is configured for linearly polarizing in a direction substantially non-parallel with respect to the first polarization axis the NIR light received by the imaging apparatus.

### FIELD OF THE DISCLOSURE

The disclosures made herein relate generally to night vision systems and methodologies and, more particularly, to polarization-based anti-blinding night vision systems and methodologies.

### BACKGROUND

In an active night-vision system of a vehicle, a near-infrared (NIR) light source with an emission wavelength typically longer than about 750 nm is used to illuminate the road over which the vehicle is travelling. Near infrared (NIR) is a subdivision in the infrared band with wavelengths between about 750 nm and about 2,500 nm, which is not visible to the human eye. However, a complementary metal oxide semiconductor (CMOS) type camera readily images (i.e., detects) NIR light. CMOS type cameras are often used for automotive applications such as forward-collision warning, lane tracking, etc.

In a vehicle having an active night vision system, NIR light can be emitted into a headlight illumination pattern (e.g., a high-beam illumination pattern) for illuminating a road scene that is within a field of view of a CMOS type camera mounted on the exterior or interior of the vehicle. Emitting the NIR light into the headlight pattern does not hinder visibility of a driver of the opposing vehicle because the NIR light is not visible by the human eye. Through such illumination of the road scene with NIR light, an image of the road scene can be formed by the CMOS type camera mounted on the exterior or interior of the vehicle and thereafter be presented to the driver of the vehicle via a visual display.

A problem can arise when two active-night-vision-equipped vehicles approach each other in that their cameras can become blinded by the opposing vehicle's emitted NIR light. One technique for limiting this ‘system-system’ camera-blinding problem has been described in U.S. Pat. No. 6,690,017. The technique involves operating an NIR light source and NIR light imaging camera of a vehicle in a pulsed mode (e.g., with a duty cycle of typically less than 33%) and arranging for opposing night vision systems to operate out-of-phase with respect to one another. In this manner, the camera of one vehicle is imaging the road at a moment in time when the light source of the opposing vehicle is turned off. The proper pulsing phase can be set using absolute time and heading information obtained from a GPS receiver of each vehicle. While this GPS-based anti-blinding technique is effective at solving the problem of ‘system-system’ camera-blinding, it requires the use of a camera that has a global type pixel exposing mechanism (i.e., a global shutter), which selectively exposes all of the pixels on the camera at the same time (i.e., a snapshot shutter mode). However, cameras typically used in automotive applications use a rolling type pixel exposing mechanism (i.e., a rolling shutter) that continuously exposes light-sensitive pixels of the camera to incoming light and, hence, cannot be used in the anti-blinding scheme of U.S. Pat. No. 6,690,017.

Therefore, an approach for implementing anti-blinding night vision that overcomes drawbacks associated with known approaches for implementing anti-blinding night vision would be advantageous, desirable and useful.

### SUMMARY OF THE DISCLOSURE

Embodiments of the present invention are directed to a polarization-based anti-blinding night vision system. More specifically, embodiments of the present invention use linear polarization at a NIR light source and at a lens of a camera of a night vision system. Even in the case where a night vision system has a rolling shutter type camera (e.g., a night vision system of a first vehicle), implementation of the present invention precludes the camera of the night vision system from being blinded by a remote NIR light source when a field of view of the night vision system camera is directly exposed to NIR light being emitted from the remote NIR light source (i.e., a NIR light source of a night vision system of a second vehicle). In doing so, embodiments of the present invention advantageously overcome one or more shortcomings associated with known approaches for implementing anti-blinding night vision.

The underlying premise of the present invention provides for a night vision system (e.g., of a vehicle) that emits NIR night vision light in one polarization (e.g., horizontal). This light emitting arrangement can be implemented by either a horizontal polarizer at the output of a randomly polarized NIR light emitting light source of the night vision system or by using a laser with a polarized NIR light output. A night vision camera of the night vision system is equipped with a polarizer in combination with (e.g., in front of) its light receiving aperture for causing randomly polarized NIR light received at the night vision camera to become polarized in a direction substantially non-parallel to the polarization of the NIR night vision light (e.g., vertically). When the horizontally polarized NIR night vision light strikes objects in a scene (e.g., a scene in front of the vehicle), it becomes randomly polarized and reflects back to the night vision camera. Only a vertically polarized portion of this randomly polarized NIR light makes it through the polarizer into the night vision camera. Thus, the night vision camera can see objects in the scene, but will reject most of the light (i.e., horizontally polarized NIR light) emitted directly from a remote night vision system (e.g., that of an on-coming vehicle).

In one embodiment of the present invention, a night vision system comprises a night vision illuminator, an imaging apparatus, and a first light conditioning structure. The night vision illuminator is configured for illuminating a space with light that is not visible by the human eye (e.g., near infrared light) and that is linearly polarized in a direction substantially parallel with a first polarization axis. The imaging apparatus is configured for creating an electrical representation of an image defined by light received thereby that is not visible by the human eye. A field of view of the imaging apparatus includes at least a portion of the space illuminated with the light of the night vision illuminator. The first light conditioning structure is configured for linearly polarizing in a direction substantially non-parallel with respect to the first polarization axis the light received by the imaging apparatus.

In another embodiment of the present invention, a method is provided for limiting a potential for blinding of night vision cameras of on-coming vehicles. The method comprises illuminating a space forward of each one of the vehicles using a lighting apparatus thereof that emits near-infrared (NIR) light and polarizing NIR light received by a night vision camera of each one of the vehicles. The emitted NIR light is linearly polarized in a direction substantially parallel with a first polarization axis. Polarizing the received NIR light causes such received NIR light to be linearly polarized in a direction substantially non-parallel with respect to the first polarization axis.

In another embodiment of the present invention, a vehicle comprises a lighting apparatus and a camera. The lighting apparatus is configured for illuminating a space adjacent to the vehicle with near-infrared (NIR) light that is linearly polarized in a direction substantially parallel with a first polarization axis. The camera has a field of view including at least a portion of the space illuminated with the NIR light of the lighting apparatus. The camera is configured for creating an electrical representation of an image defined by NIR light received thereby. The camera includes a first light conditioning structure for linearly polarizing in a direction substantially non-parallel with respect to the first polarization axis (i.e. the polarization axis of the emitted NIR light).

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is an illustrative view showing night vision light emission and road scene light reception by a vehicle configured in accordance with an embodiment of the present invention.

FIG. 2 is a block diagram view showing the night vision light emission and the road scene light reception by a night vision system of the vehicle of FIG. 1.

FIG. 3 is a block diagram view showing a light source and light conditioning structure arrangement for providing linearly polarized light in accordance with an embodiment of the present invention.

### DETAILED DESCRIPTION OF THE DRAWING FIGURES

The disclosures made herein are directed to using polarized near-infrared (NIR) light for accomplishing anti-blinding functionality of a plurality of active night vision systems used in close proximity to each other. The night vision systems of two on-coming vehicles is one example of a plurality of light night vision systems used in close proximity to each other. While the depicted embodiments of night vision systems disclosed herein are presented in the context of a vehicle, it is disclosed herein that the present invention is not unnecessarily limited to automotive applications. NIR light is one example of a type of light that is not visible by the human eye and that can be used as a night vision light for a night vision system.

Advantageously, providing for anti-blinding functionality of active night vision systems in accordance with the present invention allows such night vision systems to be configured with non-pulsed light sources and with imaging apparatuses (e.g., cameras) that use rolling a shutter. Cameras typically used in automotive applications often have a rolling shutter, which exposes pixels of a light interpreting portion of the camera (i.e., the light imager) all the time. Rolling shutter cameras are frequently used in automotive applications because they are less expensive to build than ones with a global shutter (i.e., pixels selectively exposed via a snapshot mode of operation). Accordingly, in contrast to known GPS-based anti-blinding approaches that typically require the use of a global shutter for controlling the light exposure of camera pixels, anti-blinding functionality for night vision systems as provided by embodiment of the present invention will typically be less costly and less complex.

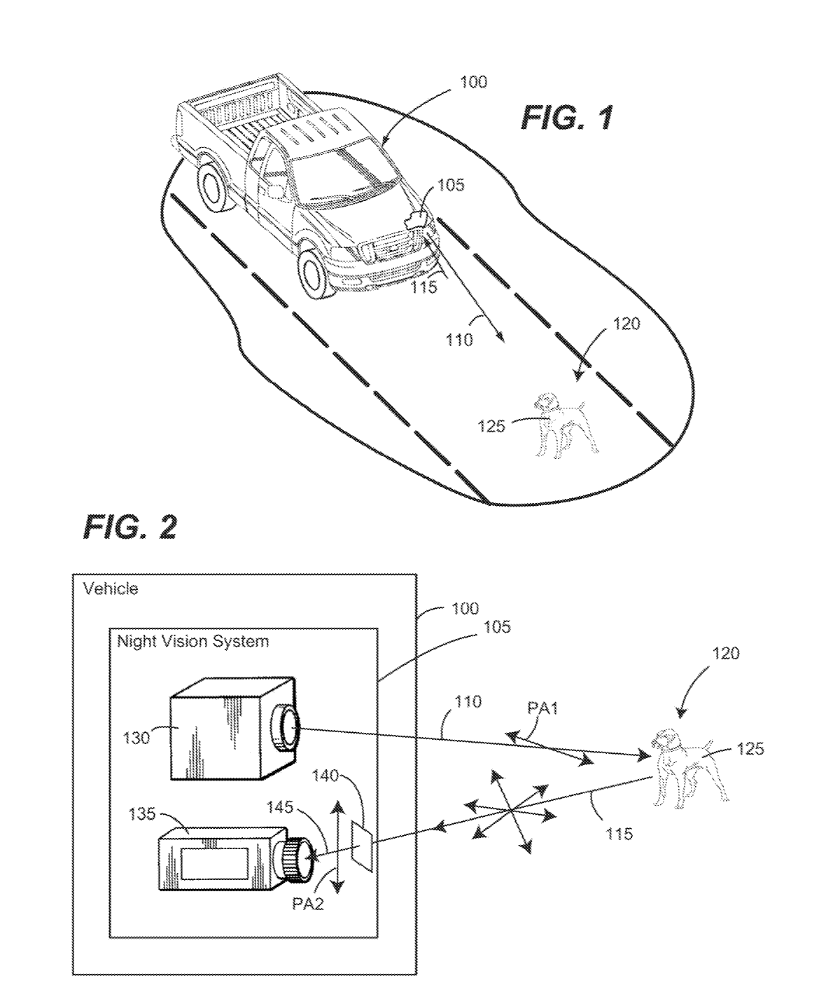

Referring now to FIGS. 1 and 2, a vehicle 100 having a night vision system 105 configured in accordance with an embodiment of the present invention is shown. The night vision system 105 provides for emission of night vision light 110 and reception an image defined by road scene light 115. A road scene 120 viewable by the night vision system 105 can include any number of fixed, movable, and/or moving objects (e.g., the moving object 125) that are within a field of view of the night vision system 105. Although the field of view of the night vision system 105 is shown as being forward of the vehicle 100, it is disclosed herein that a vehicle configured in accordance with the present invention can be provided with a night vision system or systems for providing night vision adjacent to other regions of the vehicle (e.g., to a side of the vehicle, at a rear of the vehicle, etc).

Referring to FIG. 2, the night vision system 105 includes a night vision illuminator 130, an imaging apparatus 135, and a first light conditioning structure 140. The night vision illuminator 130 is configured for illuminating a space in front of the vehicle 100 (e.g., adjacent to the vehicle 100) by means of emission of the night vision light 110. A field of view of the imaging apparatus 135 includes at least a portion of the space illuminated with the night vision illuminator 130. In one embodiment of the present invention, the night vision illuminator 130 can be integral with a headlight assembly (i.e., a lighting apparatus) of the vehicle 100 such that the NIR light can be emitted into an illumination pattern of light provided by the headlight assembly (e.g., into a high beam pattern).

The night vision light 110 is near-infrared (NIR) light that is linearly polarized in a horizontal direction. In this regard, the night vision light is horizontally polarized NIR light (i.e., NIR light that is linearly polarized in a direction substantially parallel with a first polarization axis PA1). Horizontally polarized NIR light is one example of linearly polarized NIR light. In a preferred embodiment, the first polarization axis PA1 is a horizontal polarization axis whereby the NIR light illuminating the space is horizontally polarized. Reflection of the night vision light 110 off of obstacles of the road scene 120 (e.g., the moving object 125) produces the NIR road scene light 115, which is randomly polarized NIR light. More specifically, the horizontally polarized NIR night vision light 110 will be diffusely scattered in response to impingement upon scene objects. This scattering results in a ‘randomization’ of such horizontally polarized light. Some fraction of the reflected randomly polarized NIR light will be vertically polarized.

The first light conditioning structure 140 allows only a vertically polarized portion 145 of the randomly polarized NIR road scene light 115 to be transmitted (e.g., pass) therethrough and, thus, be received by the imaging apparatus 135. Vertically polarized NIR light is one example of linearly polarized NIR light. The imaging apparatus 135 is configured for creating an electrical representation of an image defined by road scene light 115 received thereby and such image can be displayed on a visual of the vehicle 100 display (e.g., a display screen of a human machine interface of the vehicle 100). The imaging apparatus 135 can be a camera of the vehicle 100, such as that used integrated into the vehicle 100 for the purpose of providing forward-collision warning functionality, lane departure warning functionality, back-up assist functionality, and the like. Alternatively, the imaging apparatus 135 can be a camera dedicated to providing night vision functionality. In at least one embodiment, the imaging apparatus 135 is a CMOS type camera with a rolling shutter arrangement.

As can be seen, the vertically polarized portion 145 of the NIR road scene light 115 is linearly polarized in a direction substantially non-parallel with respect to the first polarization axis (i.e., extends substantially parallel with a second polarization axis PA2). It is disclosed herein that the relative angular displacement between the first and second polarization axes PA1, PA2 can be specified for accomplishing a desired degree of attenuation of a non-vertically polarized light component of the randomly polarized NIR light reflected from the road scene and/or emitted from a remote NIR light source (e.g., a night vision system of an on-coming vehicle). For example, the first and second polarization axes PA1, PA2 can be non-perpendicular while still being substantially non-parallel. In this regard, the vertically polarized portion 145 of the NIR road scene light 115 is suitable for allowing the imaging apparatus to create the electrical representation of an image defined by the randomly polarized NIR road scene light 115. The electrical representation of the image provided by the randomly polarized NIR road scene light 115 (e.g., a picture or video) can be provided to a driver and/or occupant of the vehicle via a visual display of the vehicle (e.g., an instrument cluster display), via projection onto the windshield, etc. Advantageously, night vision light emitted by an on-coming vehicle with a similarly configured night vision system as the vehicle 100 will not blind the night vision system 105 of the vehicle 100 due to the first light conditioning structure 140 inhibiting the horizontally polarized night vision light of the on-coming vehicle from being received by the imaging apparatus 135 of the vehicle 100.

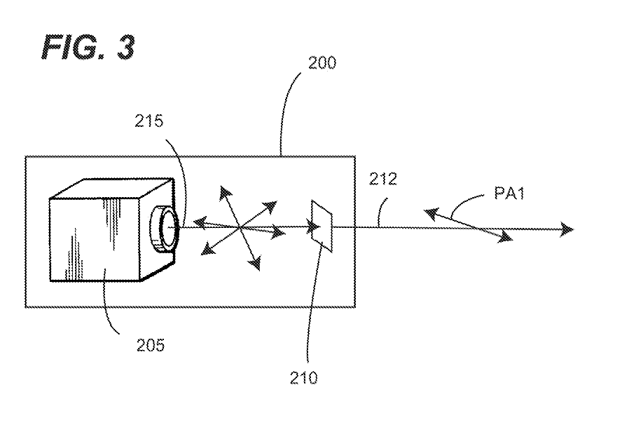

As discussed above, the night vision light 110 is NIR light that is linearly polarized in a direction substantially parallel with a first polarization axis. In a preferred embodiment, this axis can correspond to the night vision light 110 being horizontally polarized. In one embodiment, such as for the night vision illuminator 130 of FIG. 2, linearly polarized night vision light (e.g., horizontally polarized light) can be provided using a laser with a polarized output (e.g., a laser outputs horizontally polarized NIR light). As shown in FIG. 3, however, a night vision illuminator 200 (i.e., a lighting apparatus) including a light source 205 and a second light conditioning structure 210 can be configured to emit linearly polarized NW night vision light 212 (e.g., horizontally polarized NIR light) that is derived from non-linearly (e.g., randomly) polarized NIR night vision light 215. The light source 205 outputs the non-linearly polarized NIR night vision light 215. The second light conditioning structure 210 is positioned such that the randomly polarized NIR night vision light 215 impinges upon a surface of the second light conditioning structure 210. The second light conditioning structure 210 is configured such that only a horizontally polarized portion of the randomly polarized NIR night vision light 215 (i.e., the linearly polarized NIR night vision light 212) transmits through the second light conditioning structure 210.

A skilled person will appreciate that various approaches for creating linearly polarized light are well known. As such, light conditioning structures of night vision systems configured in accordance with the present invention are not unnecessarily limited to any particular type or construction of device, material or apparatus for providing linearly polarized light from randomly polarized light and/or non-linearly polarized light. A light polarizing film is one example of a suitable light conditioning structure for providing linearly polarized light from randomly polarized light. Such a light polarizing film that is configured for providing linearly polarized light from randomly polarized light can provide vertically polarized light or horizontally polarized light through the orientation of such film about an axis extending perpendicular to a surface of the film. Near infrared linear polarizing films are commercially available from sources such as, for example, American Polarizers, Inc., 3M Company, and Bolder Vision Optics.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A night vision system, comprising:
a night vision illuminator for illuminating a space with light that is not visible by the human eye and that is linearly polarized in a direction substantially parallel with a first polarization axis;
an imaging apparatus for creating an electrical representation of an image defined by light received thereby that is not visible by the human eye, wherein a field of view of the imaging apparatus includes at least a portion of the space illuminated with said light of the night vision illuminator; and
a first light conditioning structure for linearly polarizing in a direction substantially non-parallel with respect to the first polarization axis said light received by the imaging apparatus.

2. The night vision system of claim 1 wherein:
said light received by the imaging apparatus is linearly polarized in a direction substantially parallel with a second polarization axis; and
the first polarization axis is substantially perpendicular to the second polarization axis.

3. The night vision system of claim 2 wherein:
the first polarization axis is a horizontal polarization axis whereby said light illuminating the space is horizontally polarized; and
the second polarization axis is a vertical polarization axis whereby said light received by the imaging apparatus is vertically polarized.

4. The night vision system of claim 1 wherein the first polarization axis is a horizontal polarization axis whereby said light illuminating the space is horizontally polarized.

5. The night vision system of claim 4 wherein the first light conditioning structure linearly polarizes said light received by the imaging apparatus in a direction substantially perpendicular with respect to the first polarization axis.

6. The night vision system of claim 1 wherein the night vision illuminator includes a light source that outputs said horizontally polarized light.

7. The night vision system of claim 6 wherein:
said light received by the imaging apparatus is linearly polarized in a direction substantially parallel with a second polarization axis; and
the first polarization axis is substantially perpendicular to the second polarization axis.

8. The night vision system of claim 6 wherein the first polarization axis is a horizontal polarization axis whereby said light illuminating the space is horizontally polarized.

9. The night vision system of claim 1, further comprising:
a second light conditioning structure, wherein the night vision illuminator includes a light source that outputs randomly polarized light and wherein said randomly polarized light is exposed to the second light conditioning structure for causing said randomly polarized light to become horizontally polarized.

10. The night vision system of claim 9 wherein:
said light received by the imaging apparatus is linearly polarized in a direction substantially parallel with a second polarization axis; and
the first polarization axis is substantially perpendicular to the second polarization axis.

11. The night vision system of claim 9 wherein the first polarization axis is a horizontal polarization axis whereby said light illuminating the space is horizontally polarized.

12. A method for limiting a potential for blinding of night vision cameras of on-coming vehicles, the method comprising:
illuminating a space forward of each one of said vehicles using a lighting apparatus thereof that emits near-infrared (NIR) light, wherein said emitted NIR light is linearly polarized in a direction substantially parallel with a first polarization axis; and
polarizing NIR light received by a night vision camera of each one of said vehicles, wherein said polarizing causing said NIR light received by the night vision camera of each one of said vehicles to be linearly polarized in a direction substantially non-parallel with respect to the first polarization axis.

13. The method of claim 12 wherein:
said NIR light received by the imaging apparatus is linearly polarized in a direction substantially parallel with a second polarization axis; and
the first polarization axis is substantially perpendicular to the second polarization axis.

14. The method of claim 13 wherein:
the first polarization axis is a horizontal polarization axis whereby said NIR light illuminating the space is horizontally polarized; and
the second polarization axis is a vertical polarization axis whereby said NIR light received by the imaging apparatus is vertically polarized.

15. The method of claim 12 wherein said polarizing includes exposing randomly polarized NIR light to a first light conditioning structure for causing said randomly polarized NIR light to become linearly polarized in the direction substantially non-parallel with respect to the first polarization axis.

16. The method of claim 12 wherein said illuminating includes outputting said NIR light from a light source of the lighting apparatus.

17. The method of claim 12 wherein said illuminating includes:
outputting randomly polarized NIR light from a light source of the lighting apparatus; and
exposing said randomly polarized light to a second light conditioning structure for causing said randomly polarized light to become linearly polarized in the direction substantially parallel with the first polarization axis.

18. A vehicle, comprising:
a lighting apparatus configured for illuminating a space adjacent to the vehicle with near-infrared (NIR) light that is linearly polarized in a direction substantially parallel with a first polarization axis; and
a camera having a field of view including at least a portion of the space illuminated with said NIR light of the lighting apparatus, wherein the camera is configured for creating an electrical representation of an image defined by NIR light received thereby and wherein the camera includes a first light conditioning structure for linearly polarizing in a direction substantially non-parallel with respect to the first polarization axis.

19. The vehicle of claim 18 wherein:
said NIR light received by the camera is linearly polarized in a direction substantially parallel with a second polarization axis; and
the first polarization axis is substantially perpendicular to the second polarization axis.

20. The vehicle of claim 19 wherein:
the first polarization axis is a horizontally polarization axis whereby said NIR light illuminating the space is horizontally polarized; and
the second polarization axis is a vertically polarization axis whereby said NIR light received by the camera is vertically polarized.

21. The vehicle of claim 18 wherein the first polarization axis is a horizontal polarization axis whereby said NIR light illuminating the space is horizontally polarized.

22. The vehicle of claim 21 wherein the first light conditioning structure linearly polarizes said NIR light received by the camera in a direction substantially perpendicular with respect to the first polarization axis.

23. The vehicle of claim 18 wherein the lighting apparatus includes a light source that outputs said horizontally polarized NIR light.

24. The vehicle of claim 23 wherein:
said NIR light received by the camera is linearly polarized in a direction substantially parallel with a second polarization axis; and
the first polarization axis is substantially perpendicular to the second polarization axis.

25. The vehicle of claim 23 wherein the first polarization axis is a horizontal polarization axis whereby said NIR light illuminating the space is horizontally polarized.

26. The vehicle of claim 18, further comprising:
a second light conditioning structure, wherein the lighting apparatus includes a light source that outputs randomly polarized NIR light and wherein said randomly polarized NIR light is exposed to the second light conditioning structure for causing said randomly polarized light to become horizontally polarized.

27. The vehicle of claim 26 wherein:
said NIR light received by the camera is linearly polarized in a direction substantially parallel with a second polarization axis; and
the first polarization axis is substantially perpendicular to the second polarization axis.

28. The vehicle of claim 26 wherein the first polarization axis is a horizontal polarization axis whereby said NIR light illuminating the space is horizontally polarized.
